(19) United States
(12) Patent Application Publication
(10) Pub. No.: US 2025/0312663 A1
(43) Pub. Date: Oct. 9, 2025

(54) ELECTRONIC GOLF FLAGSTICK AND SYSTEMS AND METHODS OF USE

(71) Applicant: Ace Golf Technologies, Lake Elmo, MN (US)

(72) Inventors: Dale Szymborski, Eden Prairie, MN (US); Robert Szymborski, Prescott, WI (US); David Otterdahl, Elko New Market, MN (US); Ashley Loyd, Santa Rosa Beach, FL (US)

(21) Appl. No.: 19/098,501

(22) Filed: Apr. 2, 2025

Related U.S. Application Data
(60) Provisional application No. 63/575,344, filed on Apr. 5, 2024.

(51) Int. Cl. A63B 57/30; A63B 57/40; H01R 13/64

(52) U.S. Cl. CPC A63B 57/357; A63B 57/40; H01R 13/64; A63B 2220/806; A63B 2220/833; A63B 2225/20; A63B 2225/50

(57) ABSTRACT

An electronic golf flagstick for sensing objects proximate the golf flagstick includes an elongated pole with a first end and a second end, the first end adapted to be removably secured to a surface. A compartment assembly is arranged between the first end and the second end. The compartment assembly includes at least one sensor configured to sense an object proximate the golf flagstick. A ferrule is disposed at the first end and includes a portion a releasably couplable electric connector.

### CROSS-REFERENCE TO RELATED APPLICATIONS

This application claims priority to U.S. Provisional Patent Application No. 63/575,344, filed Apr. 5, 2024, entitled “ELECTRONIC GOLF FLAGSTICK AND SYSTEMS AND METHODS OF USE,” which is incorporated by reference herein, in the entirety and for all purposes.

### TECHNICAL FIELD

The present disclosure is related to an electronic flagstick and systems and methods of use.

### BACKGROUND

Golf is a widely played and broadcast game worldwide. However, due to the nature of the game often being played in large spaces (indoor or outdoor), along with the relatively small ball, and the need to keep the playing area free of people such as camera personnel, it can be difficult to capture the best images where many of the crucial moments of the game occur (e.g., at the hole on the green). Therefore, better systems and methods are needed to capture images, video, and sound where the action is.

### SUMMARY

In one embodiment, an electronic golf flagstick configured for sensing objects proximate the golf flagstick, includes: an elongated pole including a first end and a second end, the first end adapted to be removably secured to a surface; a compartment assembly arranged between the first end and the second end, the compartment assembly including at least one sensor configured to sense an object proximate the golf flagstick; and a ferrule disposed at the first end and including a portion of a releasably couplable electric connector.

Optionally, in some embodiments, the portion of the releasably couplable electric connector includes a second portion; and the releasably couplable electric connector further includes a first portion complementary in shape to the second portion, such that when the first end is removably secured to the surface, an electrical connection is established between the first portion and the second portion.

Optionally, in some embodiments, the first portion includes a substrate with one or more first plurality of electrical contacts coupled to the substrate and configured for physical and electrical interface with a corresponding second plurality of contacts of the second portion.

Optionally, in some embodiments, the first plurality of electrical contacts is arranged in redundant pairs.

Optionally, in some embodiments, the first portion further includes a connector coupled to the substrate, in electrical communication with the one or more contacts, and configured to enable a wired connection to a device.

Optionally, in some embodiments, the device includes a portion of a golfing system.

Optionally, in some embodiments, the device includes an Ethernet switch with a power-over-Ethernet capability.

Optionally, in some embodiments, the second portion includes a substrate including a second plurality of electrical contacts coupled thereto and configured for physical and electrical interface with corresponding first plurality of electrical contacts of the first portion, and the second plurality of electrical contacts are arranged in a nested circular pattern.

Optionally, in some embodiments, the ferrule engages the surface, an electrical connection is established between the first releasably couplable electric connector and the second releasably couplable electric connector.

Optionally, in some embodiments, an interaction between the ferrule and the surface limits misalignment of the first portion and the second portion to less than about 0.4°.

Optionally, in some embodiments, when the first end is removably secured to the surface, an interaction between the ferrule and the surface limits compression of the first plurality of electrical contacts by the second plurality of electrical contacts to within an elastic compression distance.

Optionally, in some embodiments, the releasably couplable electric connector is configured to supply at least one of an electrical power or a data connection to the compartment assembly.

In one embodiment, a game system includes: a releasably couplable electric connector; a golf cup; a first portion of the releasably couplable electric connector coupled to the golf cup; an electronic flagstick including: an elongated pole with a first end and a second end, a ferrule coupled to the first end and releasably coupleable to the golf cup, and a second portion of the releasably couplable electric connector coupled to the ferrule, wherein when the ferrule is releasably coupled to the golf cup, the first portion and the second portion establish an electrical connection therebetween.

Optionally, in some embodiments, the game system includes: a sensor coupled to the electronic flagstick; and a processor, wherein the processor and the sensor are in intermittent electrical communication via the releasably couplable electric connector.

Optionally, in some embodiments, the sensor includes a camera configured to capture a 360° view of a location proximate to the flagstick.

Optionally, in some embodiments, the processor is configured to broadcast a live image of the location based on the 360° view.

Optionally, in some embodiments, the processor is configured to change a displayed vantage point within the 360° view.

In one embodiment, a releasably couplable electric connector includes: a first portion including a first substrate; a first plurality of electrical contacts coupled to the first substrate; a second portion including a second substrate; a second plurality of electrical contacts coupled to the second substrate, wherein the second plurality of electrical contacts are arranged in a nested circular pattern and the first plurality of electrical contacts are arranged in redundant pairs and positioned to make releasably coupleable electrical contact with the first plurality of electrical contacts.

Optionally, in some embodiments, the second substrate includes a plurality of rim portions extending from a circumference thereof.

Optionally, in some embodiments, the releasably couplable electric connector includes a ferrule, the ferrule including: an elongated body including: a first end, a second end longitudinally opposite the first end, a conical portion at the first end; a cylindrical portion at the second end, and a receptacle formed within at least a portion of the cylindrical portion and accessible from the second end; a castellated portion extending longitudinally from the second end and including a plurality of alternating elevated portions and recessed portions, wherein each of the plurality of recessed portions are of a complementary shape configured to receive a respective one of the plurality of rim portions.

In one embodiment, a method of sensing an object proximate to a golf hole includes: releasably coupling a releasably couplable electric connector to establish electrical communication between a sensor and a processing element. A first portion of the releasably couplable electric connector is coupled to a cup associated with the golf hole, a second portion of the releasably couplable electric connector is coupled to an end of an elongated pole, and the sensor is coupled to the elongated pole and configured to sense the object proximate the golf hole; powering, via the releasably couplable electric connector, the sensor; receiving, via the sensor, data related to a location proximate to the hole; and transmitting, via the releasably couplable electric connector, the data to the processing element.

Optionally, in some embodiments, the data includes at least one of an image or a sound.

Optionally, in some embodiments, the end of the elongated pole includes a first end adapted to be removably secured to a surface of the cup; the elongated pole includes a second end opposite the first end; a compartment assembly is arranged between the first end and the second end, the compartment assembly including the sensor; and a ferrule is disposed at the first end and includes the second portion of the releasably couplable electric connector.

Optionally, in some embodiments, the first portion is complementary in shape to the second portion, such that when the first end is removably secured to the surface, the electrical communication is established between the first portion and the second portion.

Optionally, in some embodiments, the method of claim 21, further includes, uncoupling the releasably couplable electric connector to sever the electrical communication.

### BRIEF DESCRIPTION OF THE DRAWINGS

FIG. 1 is a schematic of an embodiment of a gaming system including an electronic flagstick according to implementations of the present disclosure according to implementations of the present disclosure.

FIG. 2 is a schematic of an embodiment of the gaming system of FIG. 1 including an electronic flagstick and an optional base, according to implementations of the present disclosure according to implementations of the present disclosure.

FIG. 3 is a schematic view of an electronic flagstick 500 for use with any embodiment of a gaming system herein.

FIG. 4A is a schematic view of a portion of an electronic flagstick including a releasably couplable electric connector for use with any gaming system disclosed herein, in a first configuration according to implementations of the present disclosure.

FIG. 4B is a schematic view of a portion of an electronic flagstick including an embodiment of a releasably couplable electric connector for use with the any gaming system disclosed herein, in a second configuration according to implementations of the present disclosure.

FIG. 4C is a schematic view of a portion of an electronic flagstick including an embodiment of a releasably couplable electric connector for use with the any gaming system disclosed herein, in a second configuration according to implementations of the present disclosure.

FIG. 4D is an embodiment of a cup for use with any gaming system disclosed herein, according to implementations of the present disclosure.

FIG. 4E is a section view of the cup of FIG. 4D, taken along line 2D-2D of FIG. 4D according to implementations of the present disclosure.

FIG. 4F is a bottom isometric view of the cup of FIG. 4E and the releasably couplable electric connector of FIG. 4A according to implementations of the present disclosure.

FIG. 4G is a bottom, partially-exploded isometric view of the cup of FIG. 4E and the releasably couplable electric connector of FIG. 4A according to implementations of the present disclosure.

FIG. 4H is an upper, partially-exploded isometric view of the cup of FIG. 4E and the releasably couplable electric connector of FIG. 4A according to implementations of the present disclosure.

FIG. 4I is an isometric view of a portion of the releasably couplable electric connector of FIG. 4A according to implementations of the present disclosure.

FIG. 5A is an isometric view of an embodiment of a ferrule for use with the releasably couplable electric connector of FIG. 4A according to implementations of the present disclosure.

FIG. 5B is a bottom plan view of the ferrule of FIG. 5A according to implementations of the present disclosure.

FIG. 5C is a section view of the ferrule of FIG. 5A taken along line 3C-3C of FIG. 5B according to implementations of the present disclosure.

FIG. 5D is a partially exploded, bottom isometric view of a portion of the releasably couplable electric connector of FIG. 4A, including the ferrule of FIG. 5A according to implementations of the present disclosure.

FIG. 5E is a bottom isometric view of the portion of the releasably couplable electric connector of FIG. 4A, including the ferrule of FIG. 5A, shown in FIG. 5D according to implementations of the present disclosure.

FIG. 5F is a detailed lower isometric view of the portion of the releasably couplable electric connector of FIG. 4A, including the ferrule of FIG. 5A, shown in FIG. 5D according to implementations of the present disclosure.

FIG. 5G illustrates a portion of a releasably couplable electric connector in accordance with certain embodiments of the present disclosure.

FIG. 6 is a cross section view of the assembled releasably couplable electric connector of FIG. 4A according to implementations of the present disclosure.

FIG. 7 is a cross section view of the cup of FIG. 4D and the portion of the releasably couplable electric connector of FIG. 4A with a standard flagstick according to implementations of the present disclosure.

FIG. 8A is an elevation view of an embodiment of a compartment assembly of the flagstick of FIG. 1 including one or more sensors according to implementations of the present disclosure.

FIG. 8B is another elevation view of an embodiment of the compartment assembly of FIG. 8A according to implementations of the present disclosure.

FIG. 8C-FIG. 8F are detailed views of an embodiment of a sensor of the compartment assembly of FIG. 8A according to implementations of the present disclosure.

FIG. 9 is a flowchart of a method of sensing an object proximate to a golf hole using the system of FIG. 1 according to implementations of the present disclosure.

FIG. 10 is a simplified block diagram of components of a computing system of the gaming system of FIG. 1 according to implementations of the present disclosure.

### DETAILED DESCRIPTION

The systems, methods, and devices disclosed herein enable the capture of images (including still images and video) and sounds of a golf game from where the most intense action often occurs, e.g., at the hole. The disclosed systems use a novel electronic flagstick (or pin) with one or more sensors that detect images 360° around the flagstick. For example, the 360° view may include a view of one or both of a ground surface or sky. The flagstick includes a releasably couplable electric connector in the ferrule at the base of the flagstick that makes power and/or data electrical connections to other portions of the system when the flagstick is placed in the cup on the green. The releasably couplable electric connector provides power to the flagstick and/or enables the flagstick to transmit images and/or sounds to other parts of the system. The data fed from the flagstick can be post-processed, such as by a computing device, to show a custom view of the action from the green. For example, a producer or spectator can pan, tilt, zoom, advance or rewind footage to see the area around the flagstick from a variety of points of view, thereby creating a customized golf experience with views that cannot be achieved by any previous technology.

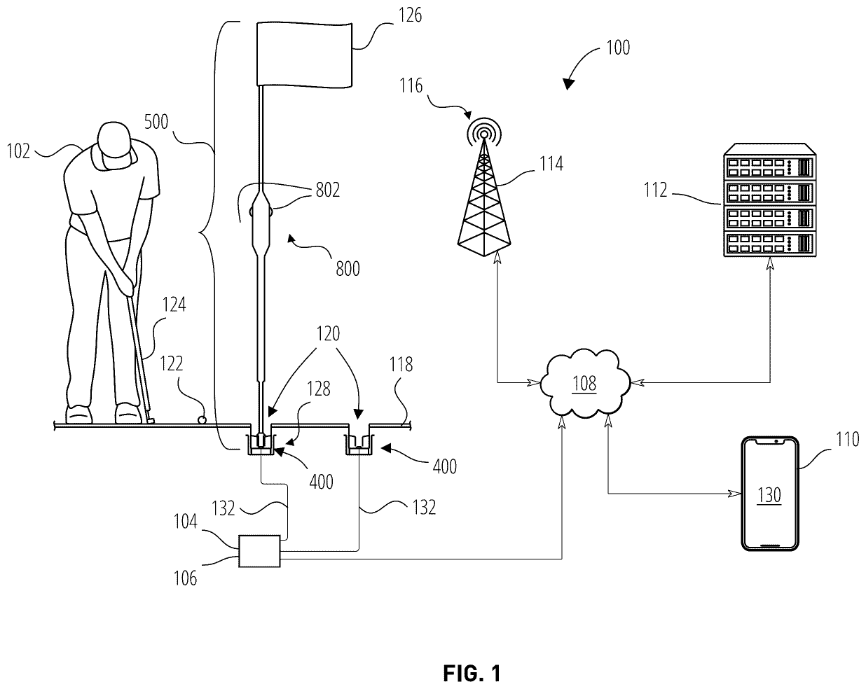

With reference to the figures, FIG. 1 shows an example of a system 100 including a flagstick 500 with a releasably couplable electric connector 128. The system 100 may implement a game such as golf (e.g., may be a golfing system 100), where one or more users 102 attempt to hit a ball 122 along a playing surface 118 into a hole 120 with a club 124. The system 100 may be used for other games than golf. The flagstick 500 may have attached thereto, a flag 126 or other marker that helps mark the location of a hole. The hole 120 may be formed by a cup 400 sunken below turf (either real or artificial) of a golf course. One or more holes 120 may be present in the system 100. In some embodiments, one hole 120 may be present in each green. In some embodiments, more than one hole 120 may be present in a green.

The flagstick 500 is releasably securable into the cup 400. A portion of the cup 400 and a portion of the flagstick 500 together form a releasably couplable electric connector 128 that supplies power and/or a data/communications connection to the flagstick 500. When the flagstick 500 is placed in the cup 400, the portions of the releasably couplable electric connector 128 may mate to form one or more electrical connections. The flagstick 500 can be releasably secured in a cup 400 such as to mark the location of the hole a user 102 such as a golfer is aiming a ball 122 toward. As a user 102 places the flagstick 500 in the cup 400, the sensors 802 of the flagstick 500 may automatically power up and begin capturing or recording images and/or sound of the area around the flagstick 500. As used herein, an electrical connection may include a power connection, a data/communications connection, or both.

In some embodiments, the flag 126 may be a fabric or membrane flag that marks the hole and/or the wind direction. In some embodiments, the releasably couplable electric connector 128 enables the flag 126 to include lights or other active components that can communicate a variety of information to a user 102, such as wind speed and direction, temperature, the hole number, their score or other information related to the game.

The cup 400 may have a connection to a cable 132 that enables the electrical connection between the cup 400 and other portions of the system 100. In some examples, the cables 132 of one or more cups 400 may connect to a switch 104, such as an Ethernet switch, router, or the like. In some embodiments, the switch 104 is optional. The switch 104 may route power and/or communications to the one or more cups 400 and thus to the flagsticks 500 when coupled with the cups 400. In some embodiments, the switch 104 provides power from a power source 106 to the cup 400 and, when coupled, to a flagstick 500. In some embodiments, the switch 104 may be a power-over-Ethernet (POE) device that provides both power (e.g., 48VDC power) to the cup 400 and also provides a data connection such as Ethernet between the flagstick 500, the cup 400, the switch 104, and/or a network 108.

The network 108 may be implemented using one or more of various systems and protocols for communications between computing devices. In various embodiments, the network 108 or various portions of the network 108 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, Wi-Fi, Zigbee, and the like. Portions of the network 108 may be wired (e.g., Ethernet or high density multimedia interface (HDMI)), while other portions may be wireless.

The system 100 may include one or more computing systems such as a server 112 or a user device 110. The server 112 or the user device 110 may be any device capable of communicating with other elements of the system 100, such as a smart phone, tablet, laptop computer, desktop computer, smart watch, control console, blade, etc. In many examples, the user device 110 may communicate via wired or wireless communications to other elements of the system 100 through the network 108. In some examples, the user device 110 may communicate directly to other elements without using a network. Generally, a computing system described as a server 112 may have greater processing, memory, and/or connectivity capabilities than a computing system described as a user device 110, which may prioritize portability over computing power.

In some embodiments, the server 112 is an editing or broadcast server 112 specifically designed for video capture, editing, playback, voiceover, commentary, subtitles, and/or broadcast. As such, the server 112 may be in communication with the transmitter 114 to enable footage (including images and/or sound) from the flagstick 500 to be broadcast in a transmission 116. The transmitter 114 may be a traditional television transmitter 114 where the transmission 116 is a radio signal. Alternately or additionally, the transmitter 114 may be a streaming server connected to the internet and the transmission 116 may be an internet video stream. In some examples, the transmitter 114 may be a satellite antenna and the transmission 116 may be sent to a satellite for further broadcast or communication. In some examples, the transmitter 114 may be a point-to-point transmitter 114 such as a microwave link, or the like. In some examples, the transmitter 114 may be a cable TV transmitter 114 and the transmission 116 a cable TV transmission. Any number and/or combination of transmitters 114 and transmissions 116 may be used as part of the system 100.

The system 100 has many benefits, such as the ability to view and broadcast a novel vantage point with unique 360° graphics of a golf game. The video feed from the flagstick 500 may provide a view from the center of the action on a golf course and may be reframed live by a user 102 through the user device 110. A user may change a displayed vantage point within the 360° view afforded by the system 100. Essentially, a user 102 may become their own camera operator in a live golf game. Additionally, or alternately, a user may replay a prior game from a whole different point of view from what they previously saw or from what was broadcast. A user may also, while watching a broadcast (e.g., a TV broadcast) of a game, may create their own supplemental content via the system 100 and the user device 110, seeing shots and scenes that were cut from the broadcast version. In some implementations, instead of the user 102 being a player of the game, the user 102 may be in control of the system 100 or portions thereof. For instance, the user 102 may implement systems and processes in connection with capture, processing and broadcasting of information from the sensors 802 of the compartment assembly 600 joined to the flagstick 300. For instance, the information captured by the sensors 602 may be images and sounds of the ball 122, the player, and the area surrounding the flagstick 300.

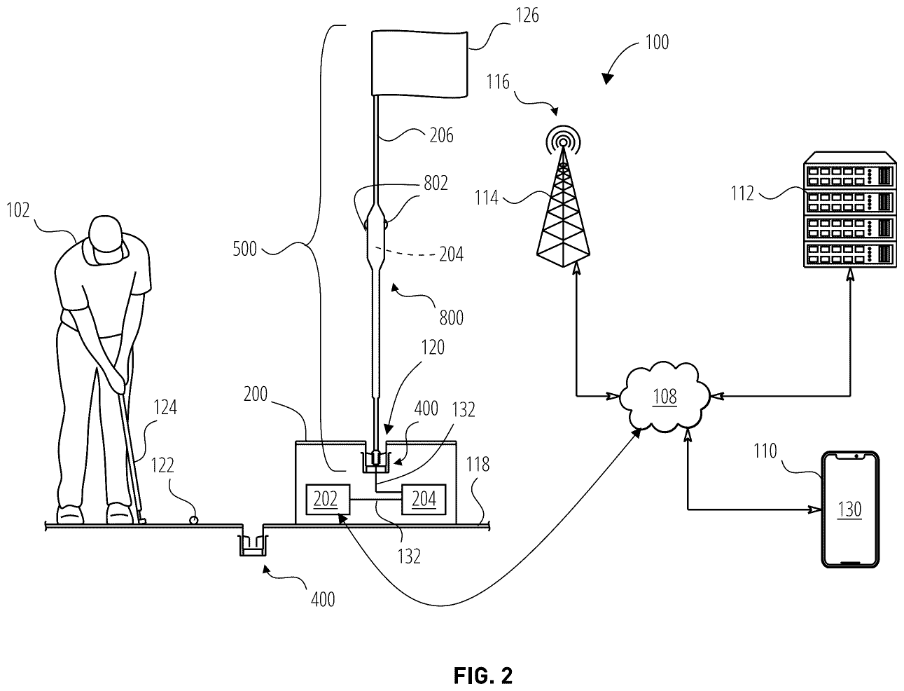

With reference to FIG. 2, the system 100 is shown with an optional base 200. Some components of the system 100 are hidden in this view for clarity (e.g., the switch 104 and the power source 106) but may still be present when the system 100 is used with a base 200. The base 200 may be moveable around the playing surface 118. In addition, the base 200 may provide a data and/or power connection to the flagstick 500 via a releasably couplable electric connector 128 as discussed herein in greater detail. For example, the base 200 may include a cup 400 as described herein. The cup 400 may be electrically coupled to a battery 204 and/or a modem 202 such as by one or more cables 132. In some embodiments, the base 200 may be weighted, such that the flagstick 500 remains in a substantially upright position even in wind or uneven terrain.

The battery 204 may provide power to the flagstick 500 and/or to the modem 202. The battery may be any suitable device that can provide power to the flagstick 500 and/or the modem 202. For example, the battery may be a “primary” or “secondary” battery, which relates to whether a battery is designed for single-use or is rechargeable, respectively. Some examples of primary batteries may include alkaline batteries or lithium batteries. Some examples of secondary batteries include lithium-ion batteries, nickel-metal hydride batteries, nickel cadmium batteries, and/or lead acid batteries. Due to their generally high mass relative to other battery types, a lead acid battery may be advantageously used to provide both a stabilizing weight and power to the base 200.

The modem 202 may provide wireless connectivity between the flagstick 500, the base 200, itself, and/or the battery 204 and the network 108 such as through a radio connection. Thus, the flagstick 500 and data from the sensors 802 may be communicated to other parts of the system 100. A radio connection may be any suitable radio technology, such as Wi-Fi, Bluetooth, satellite, “sub-gig” radio that hat operates on frequencies typically below 1-GHz (e.g., 315 MHz, 433 MHz, 868 MHz and/or 915 MHz), a cellular data connection such as General Packet Radio Service (“GPRS”), third generation (“3G”), fourth generation (“4G”), fifth generation (“5G”), etc. cellular data connection, or the like.

In some embodiments, the flagstick 500 may include an antenna 206 coupled to the modem 202 to provide the data connection from the modem 202 to the rest of the system 100. For example, an antenna 206 may be embedded or enclosed within the computing system 1000 or the elongated pole 512. In some embodiments, the elongated pole 512 itself may act as an antenna 206. The antenna 206 may be specifically adapted for any radio technology disclosed herein, or any other suitable radio technology. In some embodiments, the flagstick 500 may include a battery 204 (such as within the compartment assembly 800 and indicated by dashed lines in FIG. 2).

The base 200 is optionally provided for use with the system 100 to enable the flagstick 500 to be moved to different locations around the playing surface 118. For example, it may be advantageous to remove the flagstick 500 from the cup 400 in the playing surface 118 when a user 102 is making a putt for the hole 120. In such cases, placing the flagstick 500 in a base 200 that provides a continued power and data connection to the system 100 will enable the capture of the action near the hole 120 without getting in the way of the user 102. Further, in embodiments where the flagstick 500 includes a battery 204, the data from the flagstick 500 may be uninterrupted, and the internal battery 204 in the flagstick 500 provides power to the sensors 802 while the flagstick 500 is being transitioned between the cup 400 in the playing surface 118 and the cup 400 in the base 200. In such embodiments, the flagstick 500 may also include a memory component 1008 such as to cache the sensor 802 data while the flagstick 500 is out of communication with the system 100. The cached data may be transmitted to the system 100 when the data connection is re-established.

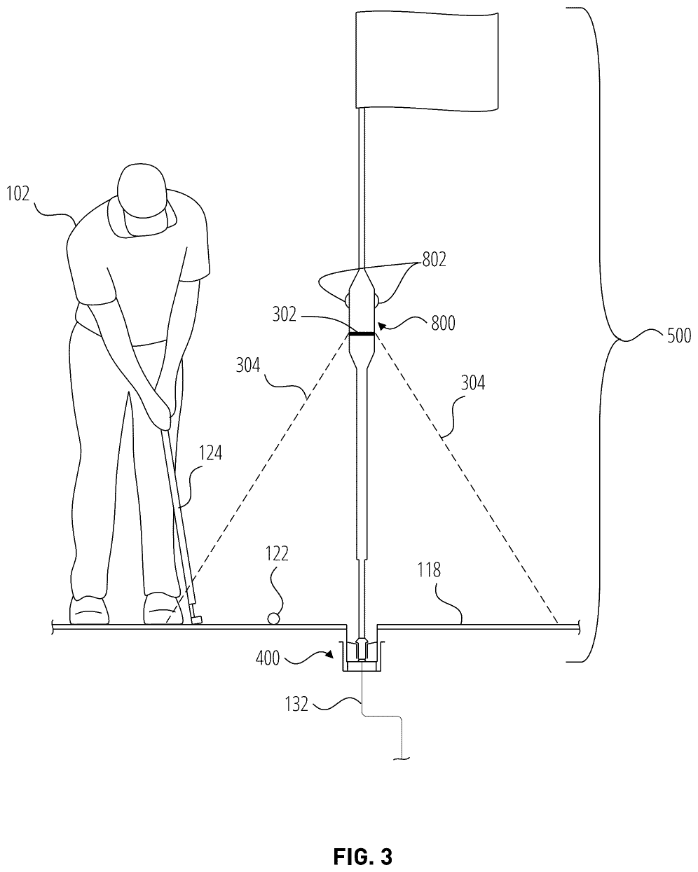

FIG. 3 is a schematic view of an embodiment of a flagstick 500 including a light source 302. The light source 302 may be powered by the system 100 via the releasably couplable electric connector 128. The light source 302 emits a light 304. For example, the light 304 may illuminate an area around the hole 120. The light 304 may be any color. The light source 302 may emit the light in any shape or pattern. For example, as shown in FIG. 3, the light 304 may be emitted in a cone (which would appear as a circle or ellipse on the 118. Although the light source 302 is shown as part of the compartment assembly 800, the light source 302 may be located on, coupled to, or adjacent to, any portion of the flagstick 500.

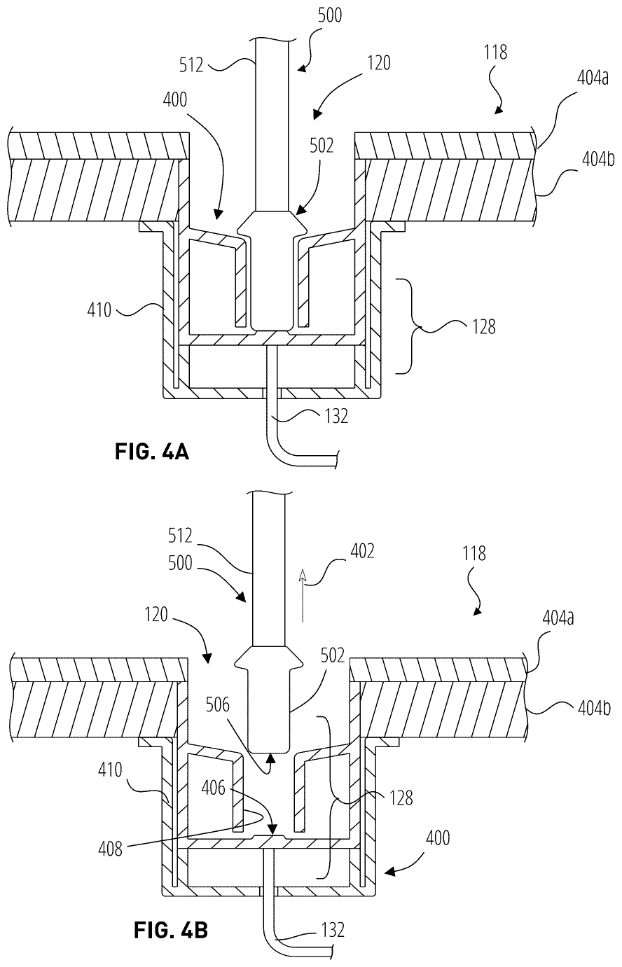

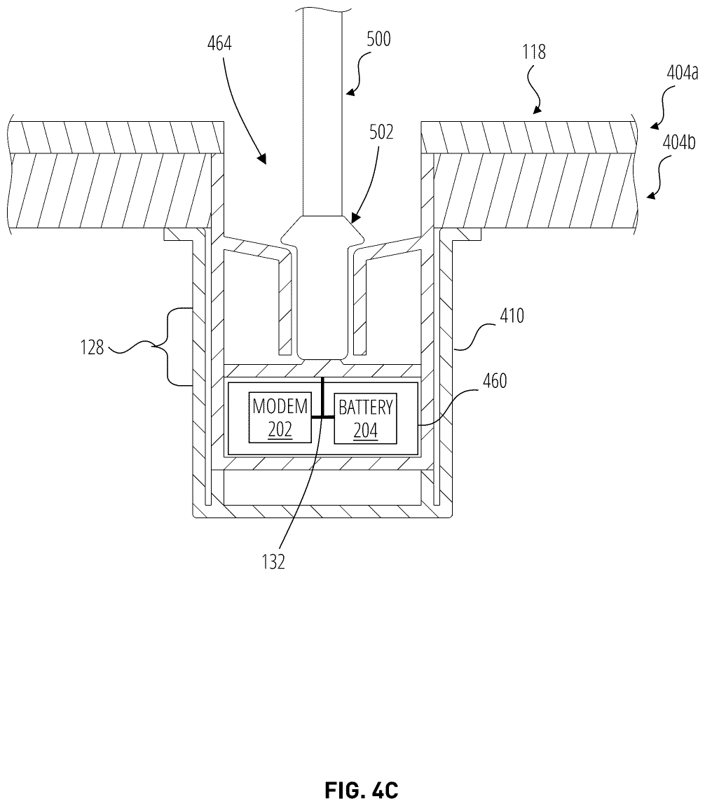

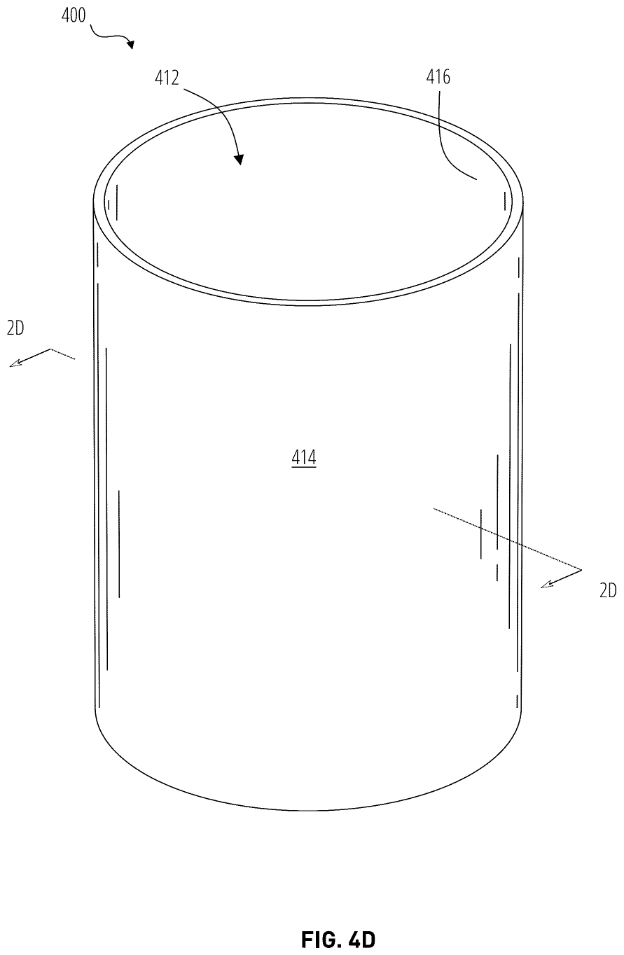

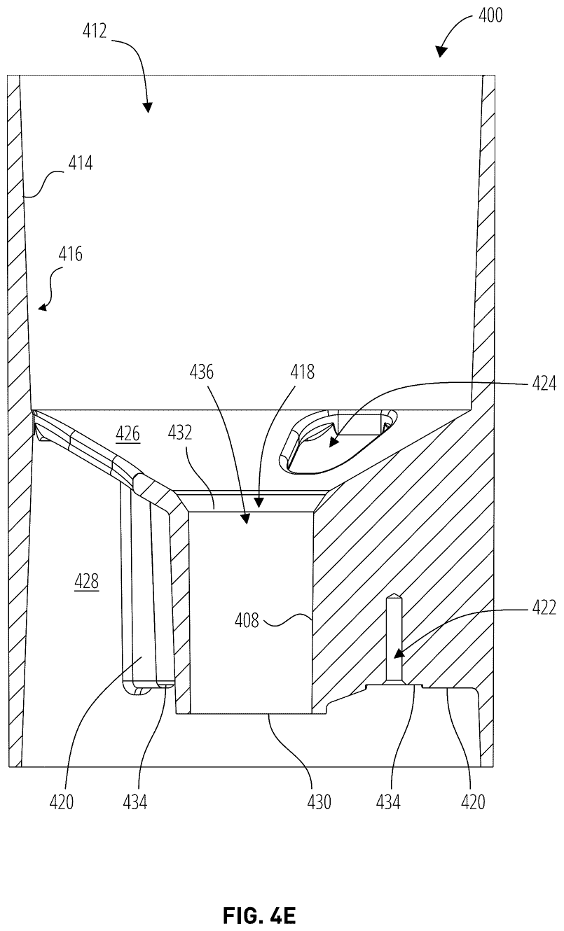

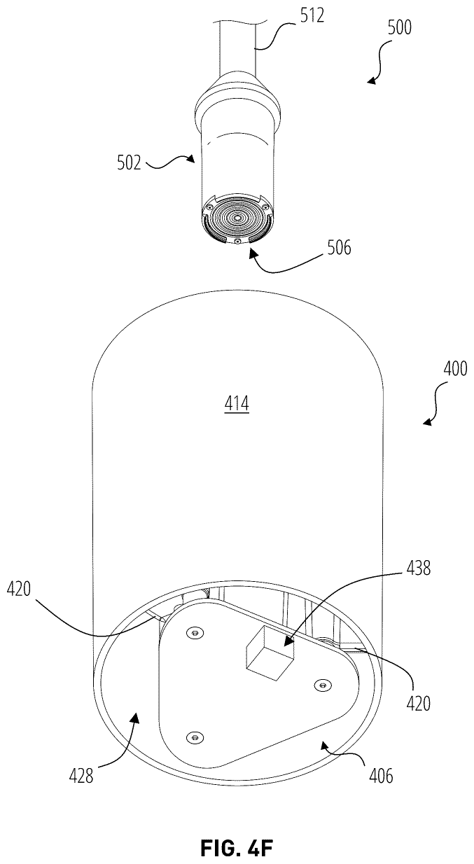

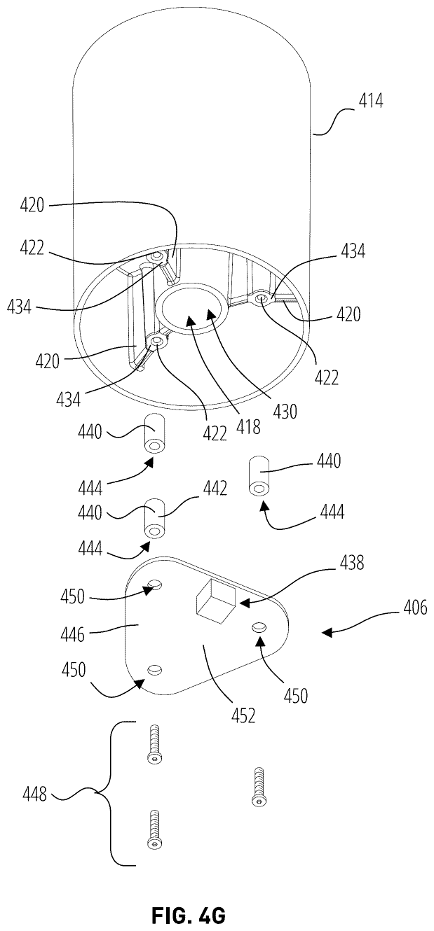

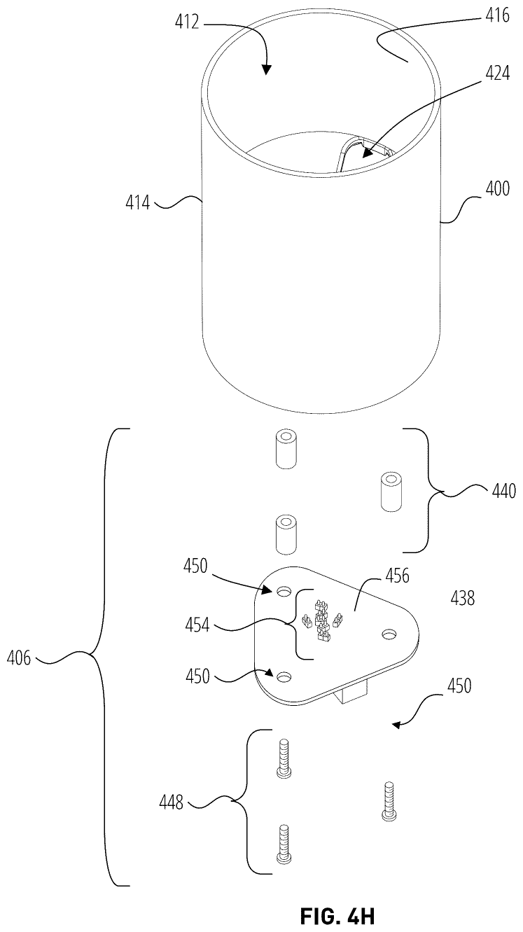

FIG. 4A and FIG. 4B show simplified schematics of a releasably couplable electric connector 128 for use with the system 100. The cup 400 is shown installed in the playing surface 118, typically with the upper portion of the cup 400 at or below the upper level of the playing surface 118, to form a hole 120 such that a ball 122 can roll into the cup 400. The cup 400 is shown received in a cup holder 410 which is optional and is typically not used in outdoor installations.

The playing surface 118 may include one or more layers. For example, an outdoor playing surface 118 may include a turf portion 404a which may be a living turf or an artificial turf and a substrate 404b such as an aggregate, sand, gravel, soil, drainage conduits, and/or combinations thereof beneath the turf portion 204a. An indoor playing surface 118 may include a turf portion 404a which may be a living turf, or an artificial turf, as well as a similar substrate 404b to that of an outdoor playing surface 118. In some embodiments, either an indoor or outdoor playing surface 118, the substrate may include a shock absorbing portion, a drainage portion, a resilient portion, and/or an impermeable portion (e.g., a rubber, plastic, or other type of barrier to water or air infiltration).

In FIG. 4A, the flagstick 500 is shown received in the cup 400 such that a ferrule 502 joined to the elongated pole 312 of the flagstick 300 is received in or engages a surface 408 of the cup 400. The ferrule 502 is releasably coupleable to the cup 400 and can be removed by withdrawing the flagstick 500 from the cup 400. When the ferrule 502 is received in the cup 400, the second portion 506 of the releasably couplable electric connector 128 and the first portion 406 of the releasably couplable electric connector 128 mate to establish an electrical connection therebetween. The releasably couplable electric connector 128 also includes a connection to other portions of the system 100, such as via a cable 132. The cable 132 may supply either or both electrical power and/or communications between the flagstick 500 and other parts of the system 100. FIG. 4B shows the flagstick 500 being removed from the cup 400 in a direction 402 (e.g., longitudinal direction). The flagstick 500 and the cup 400 and therefore the first portion 406 and the second portion 506 of the releasably couplable electric connector 128 may be in intermittent electrical contact with one another. For example, electrical contact is made when the flagstick 500 is placed in the cup 400 and broken when the flagstick 500 is removed from the cup 400.

FIG. 4C shows an example of a cup 464 with an integrated base 460. The cup 464 may be functionally similar to the cup 400 discussed herein. The base 460 may be similar to the base 200 in many respects. For example, the base 460 includes a modem 202 and battery 204. Where the base 460 differs from the base 200 is that the base 460 may be coupled to, integrated with, or adjacent to, the cup 464, e.g., below the playing surface 118. The cup 464 in these embodiments may have an extended wall 414 compared with the cup 400 shown in FIG. 4A and FIG. 4B. The extended wall 414 may provide for space below the releasably couplable electric connector 128 to house the base 460, or alternately a modem 202, and/or a 204 without a base 460. The base 460 provides power and/or data connectivity to the flagstick 500 via the releasably couplable electric connector 128 and one or more cables 132, as discussed with respect to the base 200.

FIG. 4D is an isometric view of the cup 400 for use with the system 100. The cup 400 includes a wall 414 that forms a receptacle 412 suitable to receive a ball 122 and/or a flagstick 500. The recess 428 may include a taper 416 in an upper portion thereof.

FIG. 4E is a cross-section of the cup 400 taken along line 2D-2D of FIG. 4D. The cup 400 includes a funnel 426 near a mid-portion thereof. The funnel 426 may help to keep a ball 122 that has entered the receptacle 412 from bouncing out of the cup 400. One or more drainage apertures 424 may be formed in the funnel 426 and may aid in eliminating water and/or debris from the cup 400. The drainage apertures 424 may be interspersed between one or more webs 420 formed in the cup 400.

One or more webs 420 may extend between the funnel 426 and the wall 414. In the example shown, the cup 400 includes three webs 420, although more or fewer webs 420 may be used. Each of the webs 420 may have an aperture 422 formed therein which aid in assembling the first portion 406 of the releasably couplable electric connector 128 to the cup 400 as will be discussed in further detail. A surface or edge (e.g., a lower edge) of one or more of the webs 420 may have a datum 260 formed thereon. The datums 434 may help in precise and/or accurate assembly of the releasably couplable electric connector 128 such as to maintain clearances and tolerances to aid in proper alignment and contact of the electrical contacts of the second portion 506 and first portion 406 of the releasably couplable electric connector 128. In some embodiments, the datums 434 may be machined, cast, or forged into the cup 400, or the cup may be created by additive manufacturing to include the datums 434.

A recess 428 may be formed by the wall 414, the funnel 426 (e.g., a lower surface of the funnel 426), the one or more webs 420, and the channel 418. As discussed elsewhere in greater detail, the recess 428 may receive one or more portions of the releasably couplable electric connector 128, such as a first portion 406.

A channel 418 may be formed in, or extend from the funnel 426 of the cup 400. The channel 418 may be a tubular wall defined by a surface 408 extending longitudinally along a portion of the cup 400. A guide portion 432 may be formed between the interface of the channel 418 and the funnel 426, such as along an edge therebetween. The guide portion 432 or the channel 418 may define an opening 436 into which a ferrule 502 of the flagstick 500 may be releasably received. The guide portion 432 may aid insertion of the ferrule 502 of the flagstick 500 or a ferrule of a traditional flagstick into the channel 418. For example, the guide portion 432 may be a chamfered or tapered edge of the channel 418. The surface 408 of the channel 418 may taper between the guide portion 432 and an end portion 430 of the channel 418. For example, the channel 418 may have a first diameter at an upper portion thereof and may have a second diameter at a lower portion thereof that is less than the first diameter. Thus, the surface 408 may form a wedge or funnel shape.

FIG. 4F is a bottom isometric view of the cup of FIG. 4E and the releasably couplable electric connector of FIG. 4A. The lower portion of the flagstick 500 is shown, including the ferrule 502 and the second portion 506 including one or more contacts.

As used herein, a contact may be any device or structure that enables a data/communications or power connection between two or more components. In many embodiments, a contact may be electrically conductive, such as a trace on a printed circuit board, a pin, socket, spring, etc. In some embodiments, a contact may be an optical contact (e.g., a fiber optic contact) that provides a data/communications connection but no appreciable power connection.

An example of the first portion 406 of the releasably couplable electric connector 128 is shown coupled to the cup 400 (e.g., received in the recess 428). The first portion 406 includes one or more contacts that are complementary with the contacts of the second portion 506, as discussed in greater detail herein. The first portion 406 may include a connector 438 that enables a further connection from the releasably couplable electric connector 128 to other portions or devices of the system 100. For example, the connector 438 may be adapted to receive a complementary connector and/or a cable 132 to provide a wired connection from the releasably couplable electric connector 128 to the system 100. In some embodiments, the connector 438 is a standard electrical connector such as an RJ-11,DB-9, RJ-45, HDMI, Universal Serial Bus (“USB”), Small Form-factor Pluggable (SFP), a Quad Small Form-factor Pluggable (QSFP) interface, a fiber optic connector, or other type of connector.

FIG. 4G is a bottom, partially-exploded isometric view of the cup 400 and the releasably couplable electric connector 128. FIG. 4H is an upper, partially-exploded isometric view of the cup 400 and the releasably couplable electric connector 128.

The cup 400 and first portion 406 may be coupled by one or more spacers 440. The spacers 440 may have a main body with a carefully controlled longitudinal dimension (e.g., a length). The spacers 440 may interface with respective datums 434 to accurately position the first portion 406 with respect to the cup 400. The main body of the spacer 440 may have a passage 444 formed therein. While the spacers 440 shown have largely cylindrical main bodies, in other examples, the spacers 440 may have other shapes, such as hexagonal, square, rectangular or other types of cross sections. In some embodiments, the spacer 440 may be integrally formed with either the webs 420 or the first portion 406, and separate discrete spacers 440 would not be used.

The first portion 406 includes a substrate 446 with a lower surface 452 and an upper surface 456 (shown e.g., in FIG. 4H). The substrate 446 may have one or more apertures 450 formed therein at positions and quantities that correspond to the apertures 422 formed in the webs 420. One or more fasteners 448 may be receivable in the apertures 450, passages 444 of the spacers 440, and/or the apertures 422 of the webs 420 to couple the substrate 446 to the cup 400. For example, the fasteners 448 may be screws or bolts that have threads that complement threads formed in the apertures 422 of the webs 420. In other examples, the fasteners 238 may be thread forming, self-tapping, or self-cutting screws that form threads in the passages 444 and/or the apertures 422. The connector 438 may be coupled to either the upper surface 456 or the lower surface 452 of the substrate. In some embodiments, one type of connector 438 may be coupled to one of the upper surface 456 or the lower surface 452 and another type of connector 438 may be coupled to the other of the upper surface 456 or the lower surface 452.

As shown in greater detail in FIG. 4I, one or more contacts 454 are coupled to the upper surface 456 of the substrate 446. The contacts 454 are in electrical and/or data/communications connection with the connector 438. For example, the substrate 446 may be a printed circuit board with one or more traces that electrically or optically couple the contacts 454 to corresponding contacts in the connector 438. In some embodiments, the substrate 446 may have a printed circuit board and a reinforcing plate attached thereto, such as to give the substrate 446 sufficient rigidity as not to flex to the point of losing electrical connectivity between the contacts 454 and corresponding contacts on the second portion 506 when the releasably couplable electric connector 128 is assembled.

The contacts 454 may have a base 460 and a pin 458 protruding from the base 460. The pin 458 may be biased (e.g., spring loaded) in an upward direction (e.g., toward the end portion 430 of the cup 400) when the substrate 446 is assembled with the cup 400. The pin 458 may be moveable relative to the base 460. For example, the pins 458 may have an elastic compression distance where if the pins 458 are compressed within the elastic compression distance, the pins 458 will return to their unloaded position when the compressive force is removed. The base 460 may be affixed (e.g., glued, soldered, crimped, etc.) to the substrate 446. The pin 458 may deflect or move (e.g., longitudinally) when in contact with the corresponding contact of the second portion 506. The bias may help maintain the electrical connection between the pin 458 and the corresponding contact on the second portion 506. The contacts 454 may be arranged in one or more pairs 462. In some embodiments, the pairs 462 provide positive and negative electrical connections. In some embodiments, the pairs 462 provide redundant connections to corresponding contacts of the second portion 506, such as to improve reliability of the releasably couplable electric connector 128 in the case of damage or fouling of one of the pins 458 of a pair 462.

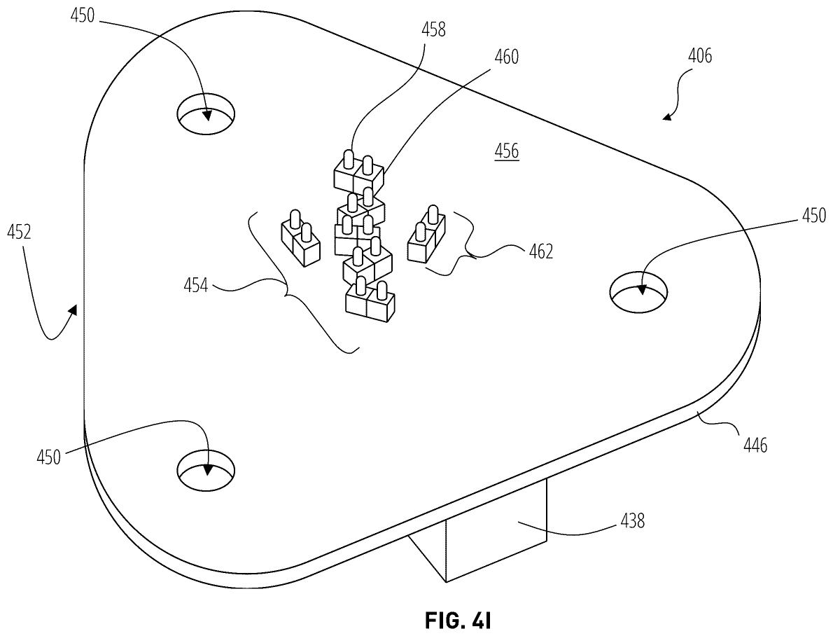

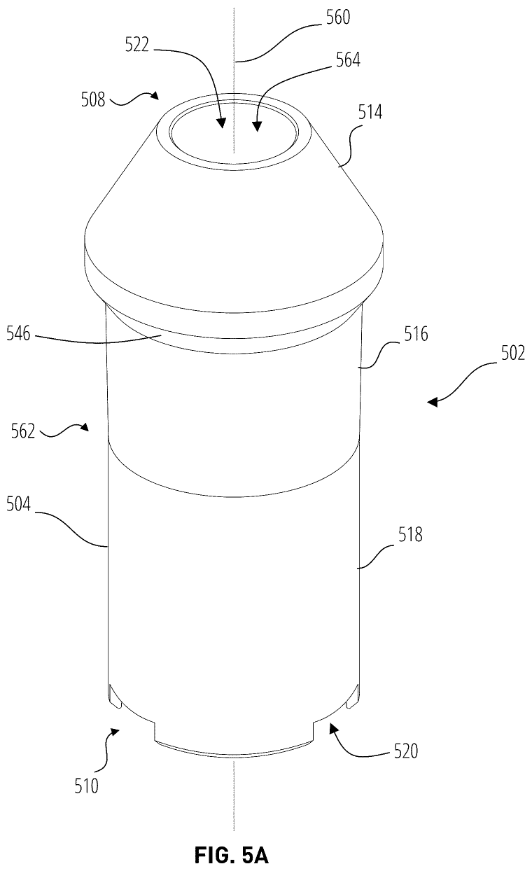

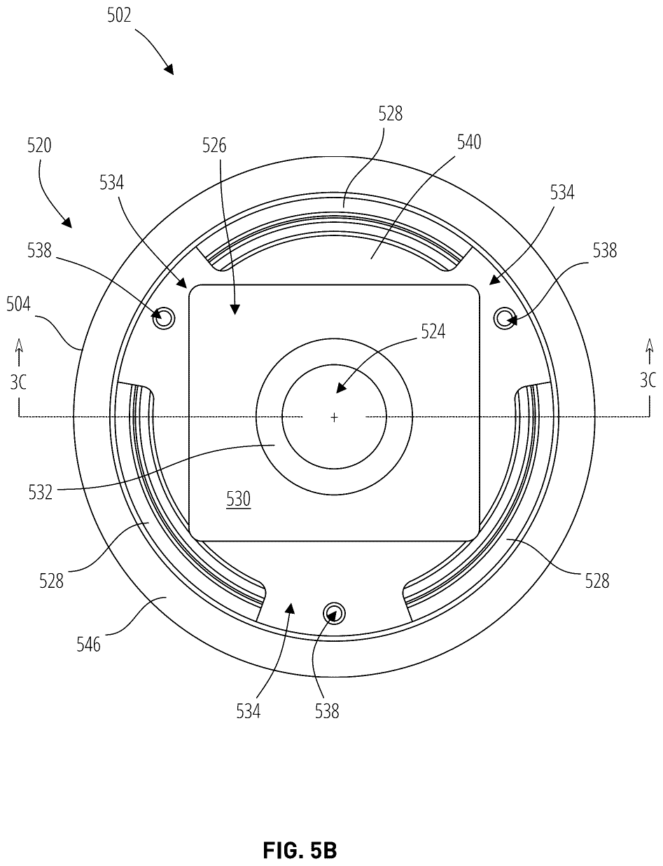

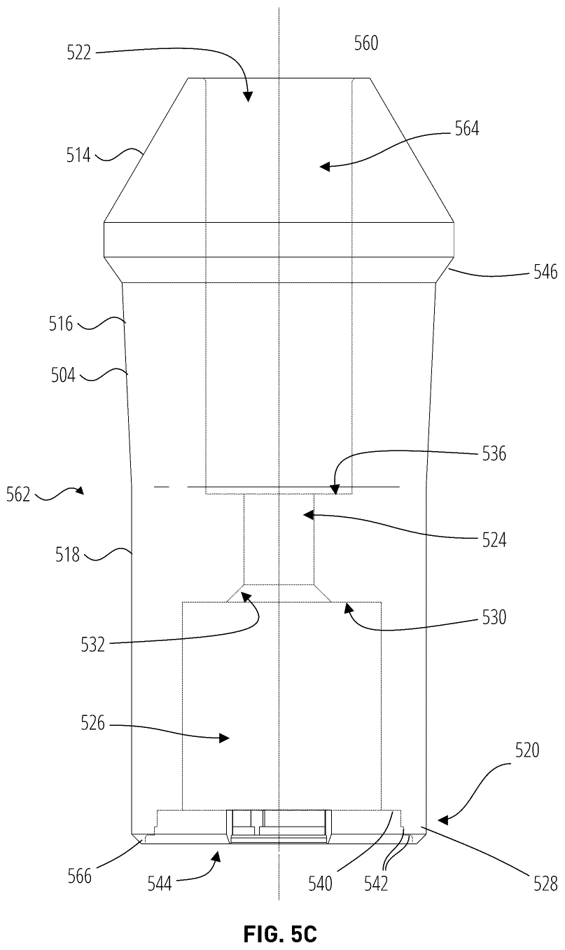

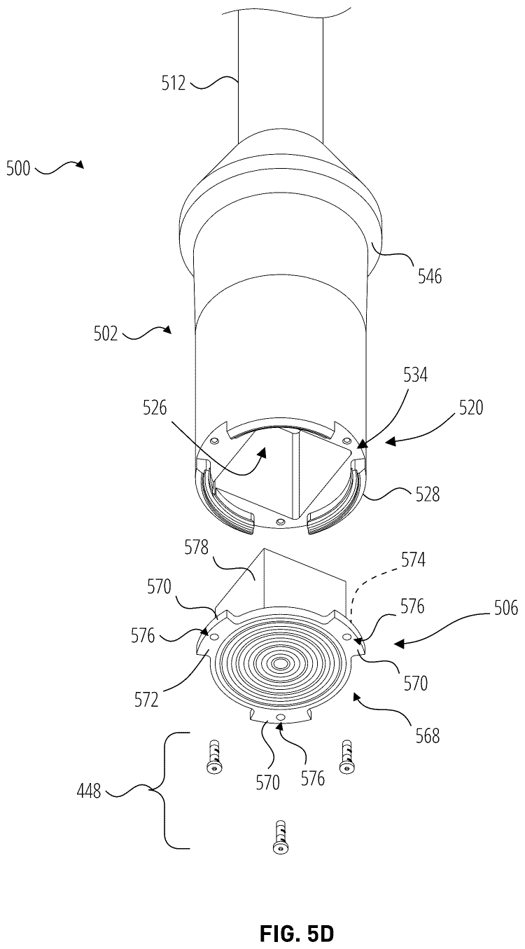

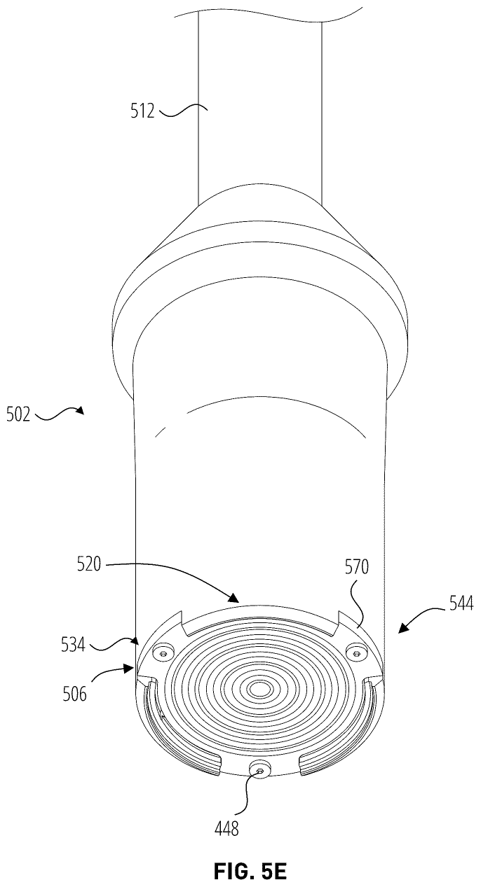

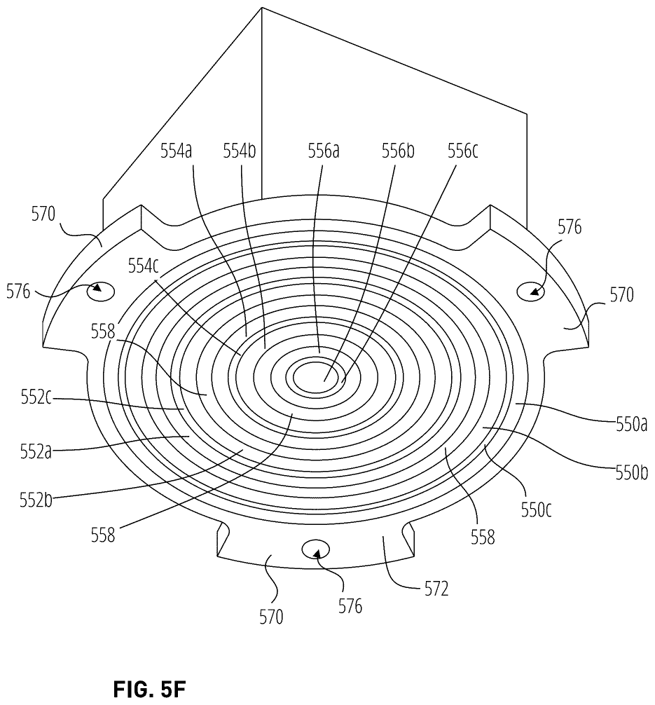

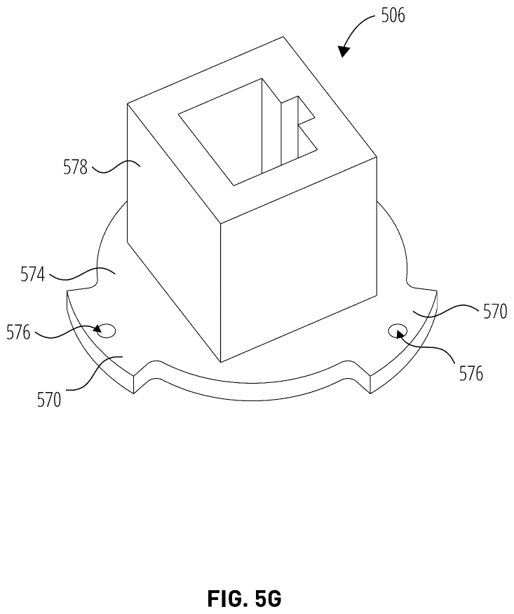

Turning now to the second portion 506 of the releasably couplable electric connector 128, FIG. 5A is an isometric view of an embodiment of a ferrule 502 for use with the releasably couplable electric connector 128. The ferrule 502 includes a main body 504 with certain features formed therein or thereon. The main body 504 may be elongated along a longitudinal axis 560 between a first end 508 (e.g., upper end) and a second end 510 (e.g., lower end) with one or more generally circular cross sections at various points along the longitudinal axis of the main body 504.

For example, the main body 504 may have a cylindrical portion 518 that extends from the second end 510 along the longitudinal axis 560 toward a mid-portion 562 of the main body 504. The cylindrical portion 518 may be longitudinally adjacent to a conical or wedge portion 516. The wedge portion 516 may flare as the wedge portion 516 progresses along the longitudinal axis 560 from the mid portion 562 toward the first end 508. For example, the diameter of the circular cross section of the wedge portion 516 near the mid portion 562 may be smaller than a diameter of the circular cross section nearer to the first end 508 of the main body 304. In other words, as the wedge portion 516 progresses upward, it becomes wider.

The wedge portion 516 may terminate at a shoulder 546 substantially wider than the widest portion of the wedge portion 516. The shoulder 546 may be shaped and positioned to interact with the guide portion 432 of the cup. See, e.g., FIG. 6 and related discussion.

The shoulder 546 may transition to a conical tip 514 that narrows as it progresses along the longitudinal axis 560 from the shoulder 546 toward the first end 508. The conical tip 514 may provide a transition from the shoulder 546 to the elongated pole 512 of the flagstick 500. A channel 522 may be formed in the first end 508 and may carry through the main body 304 along the longitudinal axis 560 toward the second end 510 of the main body 304 of the ferrule 502.

Turning to FIG. 5B and FIG. 5C, the internal structures of the ferrule 502 are shown. The channel 522 may have a variety of cross-sectional shapes to provide different features to the ferrule 502. For example, the channel 522 may have a cavity 564 roughly between the mid portion 562 and the first end 508 of the ferrule 502 that is adapted to receive the elongated pole 512. For example, the cavity 564 may be cylindrical in shape and of a size sufficiently large to accept and secure the elongated pole 512. The cavity 564 may terminate in an upper bulkhead 536 that provides longitudinal support for a corresponding end of the elongated pole 512. The upper bulkhead 536 may transmit the reaction force from the weight of the flagstick 500 interacting with the surface 408 from the ferrule 502 to the elongated pole 512.

The channel 522 may have an aperture 524 that connects the cavity 564 to a receptacle 526. The aperture 524 may be formed proximate to the mid portion 562 of the ferrule 502. The aperture 524 may provide communication between the cavity 564 and the receptacle 526, such as to enable wires or cables to pass from the second portion 506 of the releasably couplable electric connector 128 to the compartment assembly 800 on the flagstick 500 to provide power and/or communications thereto.

The receptacle 326 may be positioned along the longitudinal axis 560 between the aperture 524 and the second end 510 of the ferrule 502. The receptacle 526 may be adapted to receive the second portion 506 of the releasably couplable electric connector 128. In the example shown, the receptacle 526 has a substantially rectangular cross section. In other examples, the cross section of the receptacle 526 may be adapted for a certain second portion 506 of the releasably couplable electric connector 128. The receptacle 526 may terminate at one end in a medial bulkhead 530 (e.g., near the mid portion 562) and at an opposite end in a castellated portion 520 (e.g., near the second end 510 of the main body 442 of the ferrule 502). The channel 522 may include a tapered portion 532 disposed at an edge or transition between the receptacle 526 and the aperture 524. The tapered portion 532 may aid in installing wires or cables into the channel 522, such as by providing a funneling effect for the ends of the wires as they pass through the channel 522.

As best shown in FIG. 5B, the castellated portion 520 may include one or more elevated portions 528 (FIG. 5C) interleaved with one or more recessed portions 534. The elevated portions 528 may include chamfers 566 thereon, which may aid in inserting the ferrule 502 into the cup 400. The elevated portions 528 may rise proud of a lower bulkhead 540 at the termination of the receptacle 526 opposite the medial bulkhead 530. The interstices between the elevated portions 528 may form the recessed portions 534. One or more apertures aperture 538 may be formed in the lower bulkhead 540 and may extend along the longitudinal axis 560 at least partly into the main body 504. The elevated portion 528 may have respective steps 542 formed therein e.g., on an interior surface thereof). The castellated portion 520 and its constituent components (e.g., the elevated portions 528, the lower bulkhead 540, the aperture 524, the recessed portions 534, the apertures 538, and/or the receptacle 526 may form a socket 544 adapted to receive the second portion 506 of the releasably couplable electric connector 128.

With reference to FIG. 5D-FIG. 5G, the second portion 506 is described, along with its relation and coupling with the ferrule 502. As shown in FIG. 5D, the second portion 506 includes a substrate 568 with a lower surface 572. The substrate 568 may be similar to the substrate 446 in some respects (e.g., may be a printed circuit board or the like). The substrate 568 may have one or more rim portions 570 that protrude radially from an edge or circumference of the substrate 568. The lower surface 572 of the substrate 568 includes one or more contact 550a/b, contact 552a/b, contact 554a/b, contact 556a/b, etc. adapted to electrically couple with the contacts 454 of the first portion 406. See FIG. 5F and related discussion.

The substrate 568 may be sized and shaped to complement the socket 544 in the ferrule 502. For example, the rim portions 570 may be shaped to be received in respective recessed portions 534 of the socket 544 and between the elevated portions elevated portion 528. The rim portions 570 may have respective apertures 576 formed therein that pass through the substrate 568. The apertures 576 may be adapted to receive respective fasteners 448 to couple the second portion 506 to the ferrule 502.

As best shown in FIG. 5D and FIG. 5G, a connector 578 may be coupled to an upper surface 574 of the substrate 568. The connector 578 may be similar to the connector 438 as described herein (e.g., may be a USB, RJ-11, RJ-45, HDMI, or other electrical or optical connector with contacts therein). The contacts in the connector 578 may be electrically coupled to the contact 550a/b, contact 552a/b, contact 554a/b, contact 556a/b, etc. A cable 604 (shown on FIG. 6) or wire may be receivable in the connector 578 to electrically couple the second portion 506 (and thus the first portion 406 and other parts of the system 100) to the compartment assembly 800 and its components.

As shown in FIG. 5D and FIG. 5E, the connector 578 may be sized and shaped to be received in the receptacle 526 as the substrate 446 is fitted with the socket 544. As shown in FIG. 5E, the fasteners 448 may be received in the apertures 576 and the apertures 538 in the ferrule 502 to secure the second portion 506 to the ferrule 502, similarly as described with the fasteners 448 and the first portion 406 and cup 400. The rim portions 570 may lock the substrate 446 from rotation with respect to the ferrule 502, which maybe important to prevent or reduce twisting of the cable 604.

With reference to FIG. 5F, the lower surface 572 of the substrate 568 of the second portion 506 may include one or more electrical contacts that interface physically and electrically with the pins 458 of the first portion 406. For example, the lower surface 572 may include one or more contact 550a/b, contact 552a/b, contact 554a/b, contact 556a/b arranged in a circular fashion. The contacts may be arranged in successive nested or concentric circles or rings, or in a “bulls-eye” pattern.

For example, an outer ring may be formed by the contact 550a which may be separated from the contact 550b by a contact gap 550c. The contact gap 550c may act as an insulator to electrically isolate the contact 550a from the contact 550b and other contacts. The contact 550b may be of a smaller circumference or diameter than the contact 550a such that the contact 550b fits within a perimeter defined by the contact 550a. The contact 550a and the contact 550b may be separated from other contacts by a pair gap 558. In some embodiments, the pair gap 558 may be greater dimension than or have greater insulative properties than a contact gap 550c such as to provide noise isolation and/or minimize cross- talk between pairs of contacts.

Continuing toward a center of the substrate 568, a next inner ring of contacts may be formed by the contact 552a which may be separated from the contact 552b by a contact gap 552c. The contact gap 552c may act as an insulator to electrically isolate the contact 552a from the contact 552b and other contacts. The contact 552b may be of a smaller circumference or diameter than the contact 552a such that the contact 552b fits within a perimeter defined by the contact 552a. The contact 552a and the contact 552b may be separated from other contacts by a pair gap 558. Both of the contact 552a and contact 552b may fit within a perimeter defined by the contact 550a and the contact 550b.

Continuing further toward a center of the substrate 568, a next inner ring of contacts may be formed by the contact 554a which may be separated from the contact 354b by a contact gap 354c. The contact gap 554c may act as an insulator to electrically isolate the contact 554a from the contact 554b and other contacts. The contact 554b may be of a smaller circumference or diameter than the contact 554a such that the contact 554b fits within a perimeter defined by the contact 554a. The contact 554a and the contact 554b may be separated from other contacts by a pair gap 558. Both of the contact 554a and the contact 554b may fit within a perimeter defined by the contact 552a and contact 552b and also may fit within a perimeter defined by the contact 550a and the contact 550b.

Continuing further toward a center of the substrate 568, a next inner ring of contacts may be formed by the contact 556a which may be separated from the contact 556b by a contact gap 556c. The contact gap 556c may act as an insulator to electrically isolate the contact 556a from the contact 556b and other contacts. The contact 556b may be of a smaller circumference or diameter than the contact 556a such that the contact 556b fits within a perimeter defined by the contact 556a. The contact 556a and the contact 556b may be separated from other contacts by a pair gap 558. Both of the contact 556a and the contact 556b may fit within a perimeter defined by the contact 554a and the contact 554b, and also may fit within a perimeter defined by the contact 552a and contact 552b and also may fit within a perimeter defined by the contact 550a and the contact 550b. The contact 556b may be a solid circular contact (as opposed to the rings of the other contacts).

More or fewer contacts, and/or contact of different shapes, may be defined on the lower surface 572 of the substrate.

FIG. 6 is a cross section view of the assembled releasably couplable electric connector 128 of FIG. 4A showing the first portion 406 releasably coupled to the second portion 506 such that the pins of the first portion 406 are in electrical contact with the contacts 350a-356b of the second portion 506. For example, the bullseye arrangement of the contacts 350a-356b may be such that irrespective of the rotation of the elongated pole 512 or the ferrule about the longitudinal axis 560, the correct pins make electrical contact with the corresponding contacts 350a-356b. Thus, even if a user 102 were to twist the flagstick 500 about the longitudinal axis 560, the releasably couplable electric connector 128 will stay in electrical contact.

As shown for example in FIG. 6, the end of the elongated pole 512 may be received in the channel 522, such as in the cavity 564. The end face 548 of the elongated pole 512 may be butted adjacent to the upper bulkhead 536, such as to secure or locate the elongated pole 512 with respect to the ferrule 502. In some embodiments, the elongated pole 512 may be press-fit into the cavity 564 or may be secured with an adhesive. The cable 604 may pass out of the receptacle 526, through the aperture 524 of the ferrule 502 and into a lumen 606 of the elongated pole 512. The cable 604 may carry the electrical power/communications from the releasably couplable electric connector 128 between the compartment assembly 800 and other components in the releasably couplable electric connector 128.

Also shown in FIG. 6, the cup 400 and the ferrule 502 are of complementary shapes such that when the flagstick 500 is assembled with the cup 400, the misalignment 602 of the ferrule 302 and the channel 210 (e.g., along the longitudinal axis 560) is minimized or reduced. A user 102 may place the ferrule 502 of the flagstick 500 into the opening 436 defined by the guide portion 432 or the channel 418. As the ferrule 502 descends into the channel 418, the cylindrical portion 518 and/or the wedge portion 516 of the main body 504 of ferrule 502 may interact with the channel 418 wall to limit the relative movement of the ferrule 502 and the channel 418. For example, the surface 408 of the channel 418 and the wedge portion 516 of the ferrule 502 may be shaped such that the ferrule 502 wedges into the channel 418 of the cup 400 with a small degree of misalignment 602. For example, the cup 400 and ferrule 502 may limit the misalignment 602 to 0.5°, 0.4°, 0.3°, 0.2°, 0.1° or lower. In another example, as discussed herein, the channel 418 may taper from top to bottom such that either or both of the wedge portion 516 or the cylindrical portion 518 may be limited in movement. For example, the diameter of the channel 418 may, at some point along its length be the same as or less than a diameter of either of the cylindrical portion 518 or the wedge portion 516 such that the ferrule 502 wedges into the channel 418.

Additionally, or alternately, other features of the cup 400 and the ferrule 502 may limit the movement of the ferrule 502 along the longitudinal axis 560 into the channel 418. For example, the guide portion 432 of the cup 400 interacts with the shoulder 546 of the ferrule 502 to limit the depth to which the ferrule 502 can penetrate into the channel 418. This feature reduces the ability of the ferrule 502 to crush the pin 458 on the first portion 406. In some embodiments, the guide portion 432, shoulder 546, surface 408, and wedge portion 516 are configured to limit the compression of the pins 458 by the lower surface 572 or the contacts 550a-358b of the second portion 506 to be at, or less than, an elastic compression distance of the pins 458. Thus, repeated and reliable, releasable electrical contact can be made with the releasably couplable electric connector 128.

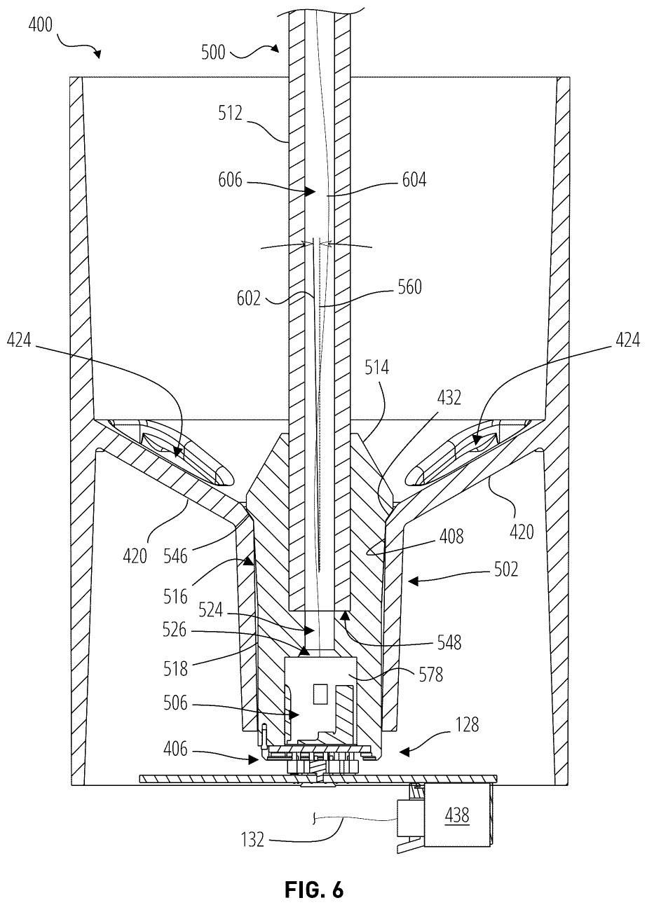

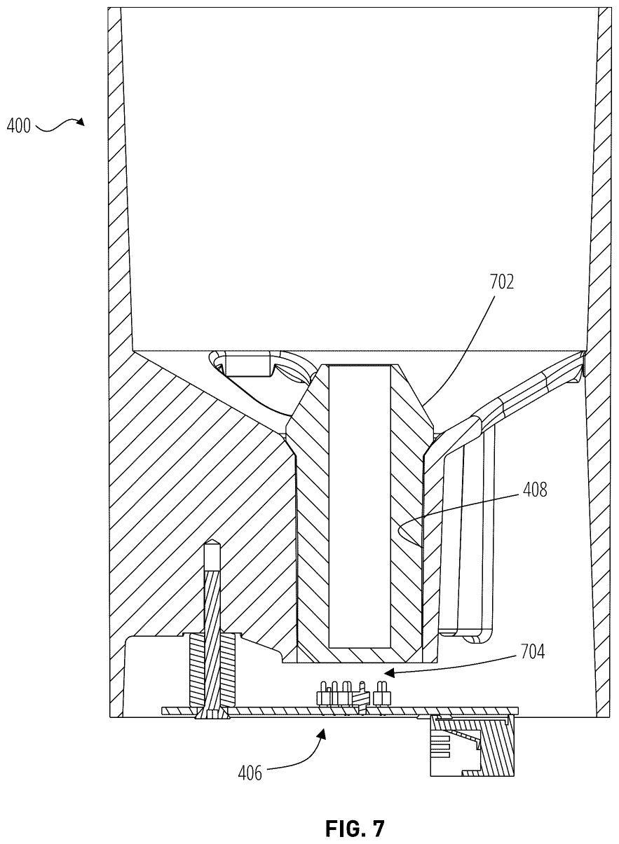

Furthermore, as shown for example in FIG. 7, the guide portion 432 and surface 408 of the cup 400 as well as the spacers 440 may be such that when a standard flagstick 702 is inserted into the cup (either intentionally or by mistake), the pins 458 are protected by a clearance 704 between the lower end of the standard flagstick 702 and the pins 458. For example, the spacers 440 can place the pins 458 and the first portion 406 low enough, and the cup 400 prevents the standard flagstick 702 from penetrating far enough into the channel 418, to damage the pins 458. This feature may help create a robust releasably couplable electric connector 128 and/or system 100.

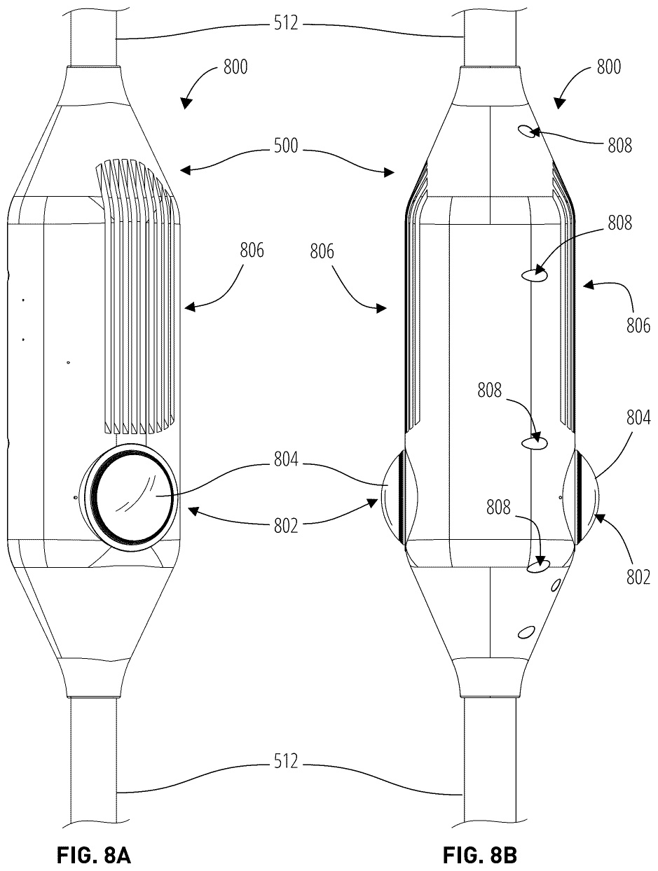

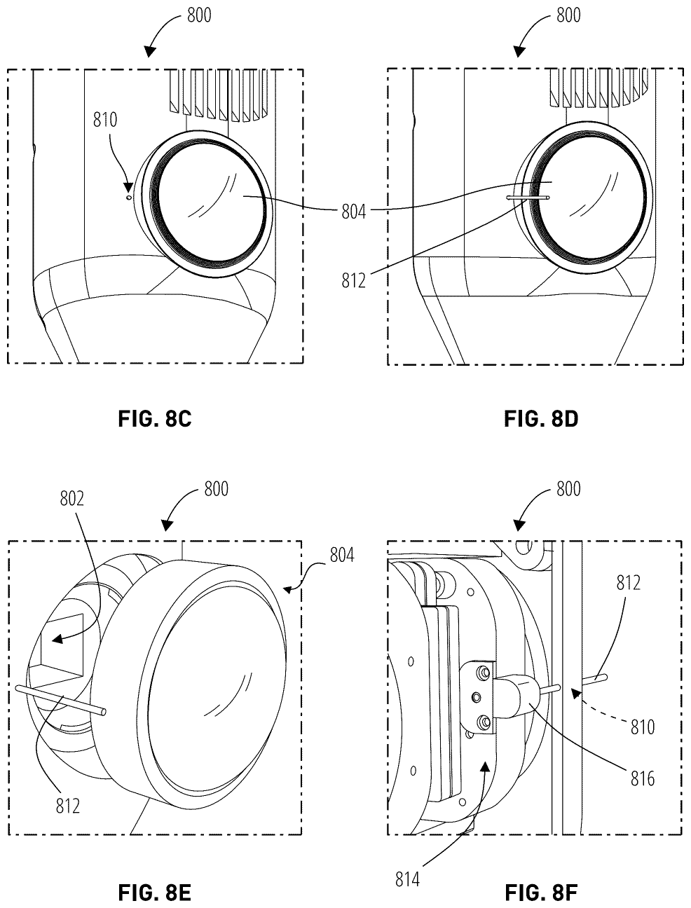

With reference to FIG. 8A-FIG. 8F features of a compartment assembly 800 are described. FIG. 8A and 6B are elevation views of an embodiment of a compartment assembly of the flagstick of FIG. 1 including one or more sensors. FIG. 8C-FIG. 8F are detailed views of an embodiment of a sensor of the compartment assembly of FIG. 8A.

The compartment assembly 800 may be formed in two or more separate sections that are clamped or otherwise attached to the elongated pole 512. For example, the compartment assembly 800 may have a shell with two portions, one of which includes apertures 808 which can receive fasteners 448 to couple the portions to one another and to the elongated pole 512 (e.g., the elongated pole 512 may be clamped between the two portions). An aperture may be formed in the elongated pole 512 to allow the cable 604 to pass to the compartment assembly 800. In some embodiments, the elongated pole 512 may be formed in two or more portions that may be coupled to one another by the compartment assembly 800.

In some embodiments, a flagstick 500 includes an elongated pole 512 to which is attached the compartment assembly 800. The compartment assembly 800 includes a sensor 802. The sensor 802 may include a camera (either still or video). Optionally, the sensor 802 may include a microphone or other device for capturing sound in the vicinity of the flagstick 500. When the sensor 802 includes a camera, the camera may have a lens 804.

In some embodiments, one sensor 802 is positioned on one face of the compartment assembly 800 and a complementary sensor 802 is positioned on an opposite face of the compartment assembly 800. In such embodiments, the two sensors 802 may be configured to capture a spherical 360° view in the vicinity of the flagstick 500. For example, the sensor 802 may be one or more cameras configured to capture a 360° view of a location proximate to the flagstick 500. For example, each sensor 802 may capture a 180° hemispherical view of the area or location around the flagstick 500 and images from the two sensors 802 may be combined (e.g., via a processing element in a user interface 130 or the server 112 into a seamless 360° image or video stream.

The sensors 802 may be powered by, and/or in electrical communication with, other parts of the system 100 via the releasably couplable electric connector 128. For example, when a user 102 places the flagstick 500 into a cup 400, the contacts in the respective first portion 406 and second portion 506 come into electrical contact and supply a data and/or power connection to the compartment assembly 800 to power and communicate with the sensors 802. In some embodiments, the compartment assembly 800 includes a heat exchanger 806 in portions thereof, such as to reject heat generated by the sensors 802 or other portions of the compartment assembly 600. In the embodiment shown, the

With reference to FIG. 8E-FIG. 8F, the lens 804 of the sensor 802 may be replaceable. As can be appreciated, high-speed golf balls and optics are seldom compatible with one another. It is likely that the lens of the sensor 802 may be damaged by impact from a ball 122, a club 124, or other object, especially then the ball 122 is generally being aimed in the direction of the flagstick 500 on which the sensor 802 is mounted. Therefore, the lens 804 is designed to be easily replaceable.

As shown for example in FIG. 8C, the shell of the compartment assembly 800 may include a keyway 810. The keyway 810 may be near the lens 804 but may also be somewhere else on the compartment assembly 800. As shown for example in FIG. 8D, the keyway 810 may receive a key 812. The key 812 may be a security key 812 coded with an electronic or mechanical code that prevents or reduces tampering by unauthorized persons. In some embodiments, the key 812 may be a simple pin that can be inserted into the keyway 810. As shown for example in FIG. 8E and FIG. 8F, inserting the key 812 into the keyway 810 may activate a latch 814 that releases the lens 804. As shown for example in FIG. 8F, the key 812 may press down on a boss 816 that releases the lens 804. A new, or undamaged, replacement lens may then be easily fitted to the compartment assembly 800.

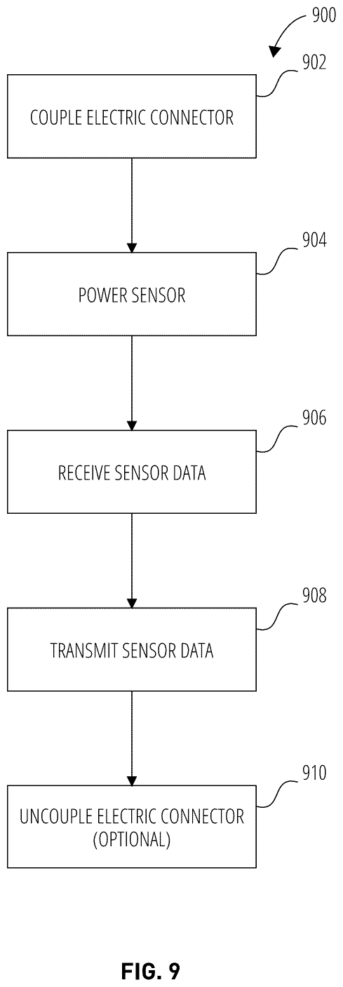

FIG. 9 illustrates an example method 900 for sensing an object proximate to a golf hole 120 with the system 100. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method 900 may begin in operation 902 and a user 102 couples the releasably couplable electric connector. As shown for example in FIG. 4A, the user 102 may place the ferrule 502 of the flagstick 500 into the cup 400. As discussed herein, when the ferrule 502 is received in the channel 418 of the cup 400 such that the ferrule 502 interacts with the surface 408, electrical communication may be established between the first portion 406 and the second portion 506 of the releasably couplable electric connector 128. See also FIG. 6 and related discussion.

According to some examples, the method 900 may proceed to operation 904 and the electrical communication established by the releasably couplable electric connector 128 may provide power to the at least one sensor 802 of the flagstick 500. For example, the releasably couplable electric connector 128 may provide the physical interface of a POE connection to provide electricity to the sensor 802. Other power connections and protocols disclosed herein may be provided by the releasably couplable electric connector 128 in the operation 904.

According to some examples, the method 900 may proceed to the operation 906 and the sensor 802 receives data related to a location proximate to the hole. For example, the sensor 802 may include a camera (still and/or video) and/or a microphone to receive an image, video, and/or sound of the location proximate to the golf hole. Other types of sensor data as discussed herein may be received.

According to some examples, the method 900 may proceed to the operation 908 and the data received by the sensor 802 in the operation 906 is transmitted via the releasably couplable electric connector 128. For example, the data may be transmitted via the 128 to the server 112, the user device 110, the switch 104, the transmitter 114, another hole 120, or the like. In some embodiments, the data may be pre-processed or converted into another form before being transmitted via the releasably couplable electric connector 128. For example, the sensor 802 may include, or be in communication with, a processing element 1002 that converts the raw sensor data into a form more suitable for use by the system 100. For example, the processing element 1002 may be located in the compartment assembly 800 and may be adapted to convert raw image sensor data and/or microphone data into a video and/or audio stream, which may be packaged in a transmission control protocol/internet protocol (TCP/IP) format, HDMI format, or other suitable format for transmission to another part of the system 100.

According to some examples, the method 900 optionally includes uncoupling the releasably couplable electric connector 128 at operation 910. As shown for example in FIG. 4B, the flagstick 500 may be removed from the cup 400, such as by moving the cup 400 in the direction 402. The flagstick 500 may be placed back into the cup 400 or into another cup 400 and the releasably couplable electric connector 128 may automatically power the sensor 802 and/or other components of the compartment assembly 800.

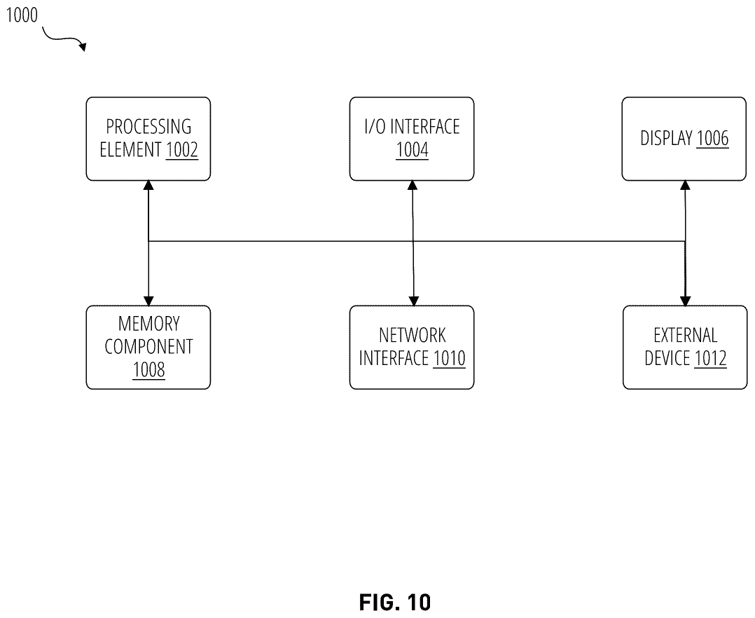

FIG. 10 is a simplified block diagram of components of a computing system 1000 of the system 100, such as the server 112, the user device 110, a sensor 802 or other components of the compartment assembly 800, etc. For example, the processing element 1002 and the memory component 1008 may be located at one or in several computing systems 1000. This disclosure contemplates any suitable number of such computing systems 1000. For example, the server 112 may be a desktop computing system, a mainframe, a blade, a mesh of computing systems 1000, a laptop or notebook computing system 1000, a tablet computing system 1000, an embedded computing system 1000, a system-on-chip, a single-board computing system 1000, or a combination of two or more of these. Where appropriate, a computing system 1000 may include one or more computing systems 1000; be unitary or distributed; span multiple locations; span multiple machines; span multiple data centers; or reside in a cloud, which may include one or more cloud components in one or more networks. A computing system 1000 may include one or more processing elements 1002, an input/output I/O interface 1004, one or more external devices 1012, one or more memory components 1008, and a network interface 1010. Each of the various components may be in communication with one another through one or more buses or communication networks, such as wired or wireless networks, e.g., the network 108. The components in FIG. 10 are exemplary only. In various examples, the computing system 1000 may include additional components and/or functionality not shown in FIG. 10.

The processing element 1002 may be any type of electronic device capable of processing, receiving, and/or transmitting instructions. For example, the processing element 1002 may be a central processing unit, microprocessor, processor, or microcontroller. Additionally, it should be noted that some components of the computing system 1000 may be controlled by a first processing element 1002 and other components may be controlled by a second processing element 1002, where the first and second processing elements may or may not be in communication with each other.

The I/O interface 1004 allows a user to enter data in to computing system 1000, as well as provides an input/output for the computing system 1000 to communicate with other devices or services. The I/O interface 1004 can include one or more input buttons, touch pads, touch screens, and so on.

The external device 1012 are one or more devices that can be used to provide various inputs to the computing system 1000, e.g., mouse, microphone, keyboard, trackpad, sensing element (e.g., a thermistor, humidity sensor, light detector, etc. The external devices 1012 may be local or remote and may vary as desired. In some examples, the external devices 1012 may also include one or more additional sensors.

The memory components 1008 are used by the computing system 1000 to store instructions for the processing element 1002 such as an application and/or user interface, as well as store data, such as video, photo, or audio data generated by the flagstick 500, user preferences, alerts, etc. The memory components 1008 may be, for example, magneto- optical storage, read-only memory, random access memory, erasable programmable memory, flash memory, or a combination of one or more types of memory components.

The network interface 1010 provides communication to and from the computing system 1000 to other devices. The network interface 1010 includes one or more communication protocols, such as, but not limited to Wi-Fi, Ethernet, Bluetooth, etc. The network interface 1010 may also include one or more hardwired components, such as a Universal Serial Bus (USB) cable, or the like. The configuration of the network interface 1010 depends on the types of communication desired and may be modified to communicate via Wi-Fi, Bluetooth, etc.

The display 1006 provides a visual output for the computing system 1000 and may be varied as needed based on the device. The display 1006 may be configured to provide visual feedback to the user 102 and may include a liquid crystal display screen, light emitting diode screen, plasma screen, or the like. In some examples, the display 1006 may be configured to act as an input element for the user 102 through touch feedback or the like.

Any description of a particular component being part of a particular embodiment, is meant as illustrative only and should not be interpreted as being required to be used with a particular embodiment or requiring other elements as shown in the depicted embodiment.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An electronic golf flagstick configured for sensing objects proximate the golf flagstick, comprising:
an elongated pole comprising a first end and a second end, the first end adapted to be removably secured to a surface;
a compartment assembly arranged between the first end and the second end, the compartment assembly comprising at least one sensor configured to sense an object proximate the golf flagstick; and
a ferrule disposed at the first end and comprising a portion of a releasably couplable electric connector.

2. The electronic golf flagstick of claim 1, wherein:
the portion of the releasably couplable electric connector comprises a second portion; and
the releasably couplable electric connector further comprises a first portion complementary in shape to the second portion, such that when the first end is removably secured to the surface, an electrical connection is established between the first portion and the second portion.

3. The electronic golf flagstick of claim 2, wherein the first portion comprises a substrate with a first plurality of electrical contacts coupled to the substrate and configured for physical and electrical interface with a corresponding second plurality of electrical contacts of the second portion.

4. The electronic golf flagstick of claim 3, wherein the first plurality of electrical contacts is arranged in redundant pairs.

5. The electronic golf flagstick of claim 3, wherein the first portion further comprises a connector coupled to the substrate, in electrical communication with one or more electrical contacts of the first plurality of electrical contacts, and configured to enable a wired connection to a device comprising a portion of a golfing system.

6. The electronic golf flagstick of claim 2, wherein:
the portion of the releasably couplable electric connector comprises a second portion; and;
the second portion comprises a substrate including a second plurality of electrical contacts coupled thereto and configured for physical and electrical interface with corresponding first plurality of electrical contacts of the first portion, and
the second plurality of electrical contacts are arranged in a nested circular pattern.

7. The electronic golf flagstick of claim 2, wherein when the ferrule engages the surface, the electrical connection is established between the first portion and the second portion.

8. The electronic golf flagstick claim 2, wherein an interaction between the ferrule and the surface limits misalignment of the first portion and the second portion to less than about 0.4°.

9. The electronic golf flagstick claim 3, wherein when the first end is removably secured to the surface, an interaction between the ferrule and the surface limits compression of the first plurality of electrical contacts by the second plurality of electrical contacts to within an elastic compression distance.

10. The electronic golf flagstick of claim 1, wherein the releasably couplable electric connector is configured to supply at least one of an electrical power or a data connection to the compartment assembly.

11. A game system comprising:
a releasably couplable electric connector;
a golf cup;
a first portion of the releasably couplable electric connector coupled to the golf cup;
an electronic flagstick comprising:
an elongated pole with a first end and a second end,
a ferrule coupled to the first end and releasably coupleable to the golf cup, and
a second portion of the releasably couplable electric connector coupled to the ferrule, wherein when the ferrule is releasably coupled to the golf cup, the first portion and the second portion establish an electrical connection therebetween.

12. The game system of claim 11, further comprising:
a sensor coupled to the electronic flagstick; and
a processor, wherein the processor and the sensor are in intermittent electrical communication via the releasably couplable electric connector.

13. The game system of claim 12, wherein:
the sensor comprises a camera configured to capture a 360° view of a location proximate to the flagstick.

14. The game system of claim 13, wherein the processor comprises a broadcast server configured to broadcast a live image of the location based on the 360° view.

15. The game system of claim 13, wherein the processor is configured to change a displayed vantage point within the 360° view.

16. A method of sensing an object proximate to a golf hole comprising:
releasably coupling a releasably couplable electric connector to establish electrical communication between a sensor and a processing element, wherein:
a first portion of the releasably couplable electric connector is coupled to a cup associated with the golf hole,
a second portion of the releasably couplable electric connector is coupled to an end of an elongated pole, and
the sensor is coupled to the elongated pole and configured to sense the object proximate the golf hole;
powering, via the releasably couplable electric connector, the sensor;
receiving, via the sensor, data related to a location proximate to the hole; and
transmitting, via the releasably couplable electric connector, the data to the processing element.

17. The method of claim 16, wherein the data comprises at least one of an image or a sound.

18. The method of claim 16, wherein:
the end of the elongated pole comprises a first end adapted to be removably secured to a surface of the cup;
the elongated pole comprises a second end opposite the first end;
a compartment assembly is arranged between the first end and the second end, the compartment assembly comprising the sensor; and
a ferrule is disposed at the first end and comprises the second portion of the releasably couplable electric connector.

19. The method of claim 18, the first portion is complementary in shape to the second portion, such that when the first end is removably secured to the surface, the electrical communication is established between the first portion and the second portion.

20. The method of claim 16, further comprising, uncoupling the releasably couplable electric connector to sever the electrical communication.
